(19) United States
(12) Patent Application Publication
(10) Pub. No.: US 2016/0303910 A1
(43) Pub. Date: Oct. 20, 2016

(54) Combined Tyre

(71) Applicant: Xiamen Lenco Co.,Ltd., Xiamen (CN)

(72) Inventor: GARY GONG, Xiamen (CN)

(21) Appl. No.: 14/689,136

(22) Filed: Apr. 17, 2015

(51) Int. Cl. B60C 7/10

(52) U.S. Cl. CPC B60C 7/102

(57) ABSTRACT

A combined tyre includes an outer tyre and a core. The outer tyre is an annular component and has an annular core groove therein. The core is an annular component. The core is mounted in the core groove of the outer tyre by means of interference fit. A gap is defined between the inner wall of the core groove of the outer tyre and the core. The present invention is composed of an outer tyre and a core. The core is disposed in the core groove of the outer tyre to prop up the inner cavity of the outer tyre so that the opening of the core groove of the outer tyre can be opened larger. During the production procedure of the present invention, the mold core to form the core groove of the outer tyre can be taken out easily to enhance the production efficiency.

### BACKGROUND OF THE INVENTION

1. Field of the Invention

The present invention relates to a tyre, and more particularly to a combined tyre.

2. Description of the Prior Art

A solid tyre is made of rubber and a foam material. Even it is used on an uneven road, it won't have a flat tyre. It is safe for use. However, the amount of deformation of the solid tyre is small. During driving, when the tyre encounters stones or other projections, the solid tyre directly transmits the acting force to the hub. This makes the driver uncomfortable. A method to manufacture a hollow solid tyre is disclosed in China, as shown in FIG. 1. The method comprises the following steps: assembling a plurality of molds to form a mold core 2′, each mold being composed of a retaining portion 21′ located at an inner side and a coupling portion 22′ located at an outer side, the retaining portion 21′ and the coupling portion 22′ being locked by screws 23′, fixing the mold core 2′ in a tyre forming mold 1′; buckling an upper mold 11′ and a lower mold 12′, injecting foam liquid through an injection hole 13′ into the space between the inner wall of the mold 1′ and the mold core 2′ and solidifying the foam liquid; taking the tyre 10′ and the mold core 2′ from the mold 1′, disassembling the mold 1′ to take out the mold parts so as to form a hollow solid tyre. During injection and forming, the hollow space is formed by combination of the detachable mold core 2′ and the foam material, and then the mold core 2′ is taken out one by one. The opening of the inner cavity of the tyre 10′ manufactured by this method is smaller to hold the mold core 2′ tightly. It is very difficult to disassemble the mold core 2′ from the tyre 10′, so the production efficiency is low. When in use, water and foreign objects may enter the conventional tyre 10′ easily through the middle opening. The bounce force from the ground directly acts on the hub through the tyre 10′ so the comfort is not good. Foreign objects, such as stones, may enter this hollow solid tyre easily because of the existence of the opening.

Accordingly, the inventor of the present invention has devoted himself based on his many years of practical experiences to solve these problems.

### SUMMARY OF THE INVENTION

The primary object of the present invention is to provide a combined tyre which has better comfort and can be mounted easily.

In order to achieve the aforesaid object, the combined tyre of the present invention comprises an outer tyre and a core. The outer tyre is an annular component and has an annular core groove therein. The core is an annular component. The core is mounted in the core groove of the outer tyre by means of interference fit. A gap is defined between the inner wall of the core groove of the outer tyre and the core.

Preferably, two sides of the core groove of the outer tyre extend inward to form flanges, respectively. The core has a stepped cross-section. A stepped surface of the core is engaged with the flanges of the core groove of the outer tyre.

Preferably, an annular outer wall of the core is formed with an annular arc recess.

The present invention has the following advantages:

1. The present invention is composed of the outer tyre and the core. The core is disposed in the core groove of the outer tyre to prop up the inner cavity of the outer tyre, so that the opening of the core groove of the outer tyre can be opened larger. During the production procedure of the present invention, the mold core to form the core groove of the outer tyre can be taken out easily to enhance the production efficiency.

2. The present invention is composed of the outer tyre and the core. The is defined between the inner wall of the core groove of the outer tyre and the core. The gap can be adjusted according to the demand, providing a better cushioning effect. The hardness of the materials for the outer tyre and the core of the present invention can be different. The comfort of the tyre is better.

3. The outer tyre and the core of the present invention are engaged with each other through a stepped surface. The engagement is firm, without disengagement.

4. The combined tyre of the present invention is composed of the outer tyre and the core, the inner cavity of the outer tyre is isolated from getting contact with the outside, so that water and foreign objects won't enter the inner cavity of the tyre.

5. The core of the present invention is made to be a standard part. PU outer tyres have different materials and patterns. Different PU outer tyres cooperate with the standard core to form different tyres.

### BRIEF DESCRIPTION OF THE DRAWINGS

FIG. 1 is a flow chart of the method to manufacture a conventional hollow solid tyre;

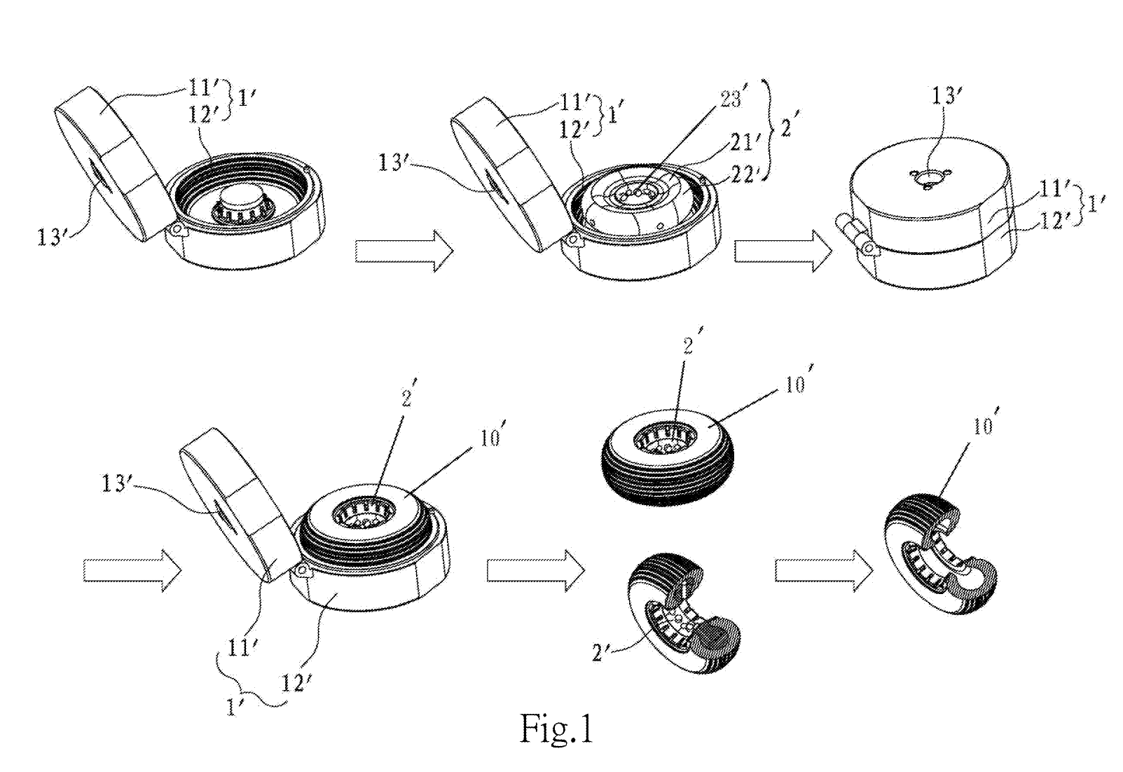

FIG. 2 is a perspective view of the present invention;

FIG. 3 is a front view of the present invention; and

FIG. 4 is a sectional view taken along line A-A of FIG. 3.

### DETAILED DESCRIPTION OF THE PREFERRED EMBODIMENTS

Embodiments of the present invention will now be described, by way of example only, with reference to the accompanying drawings.

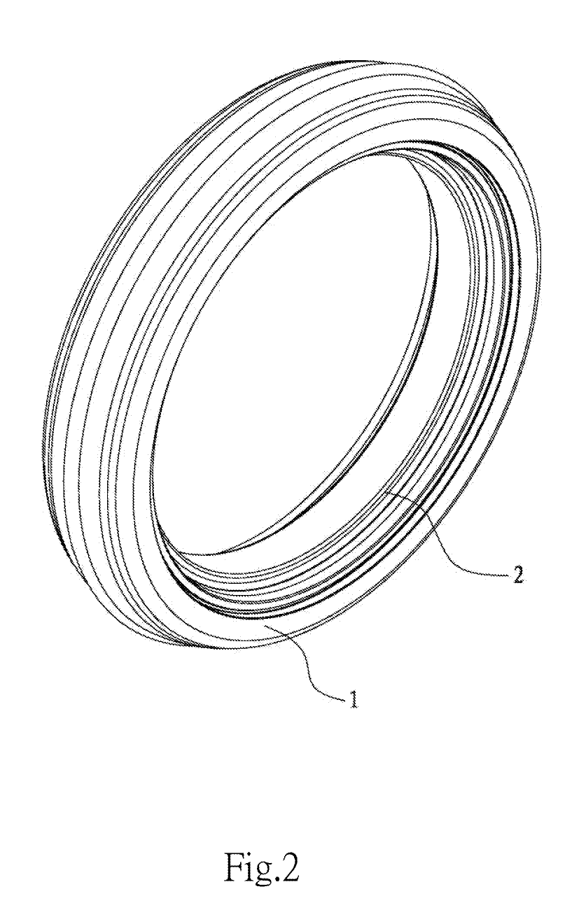

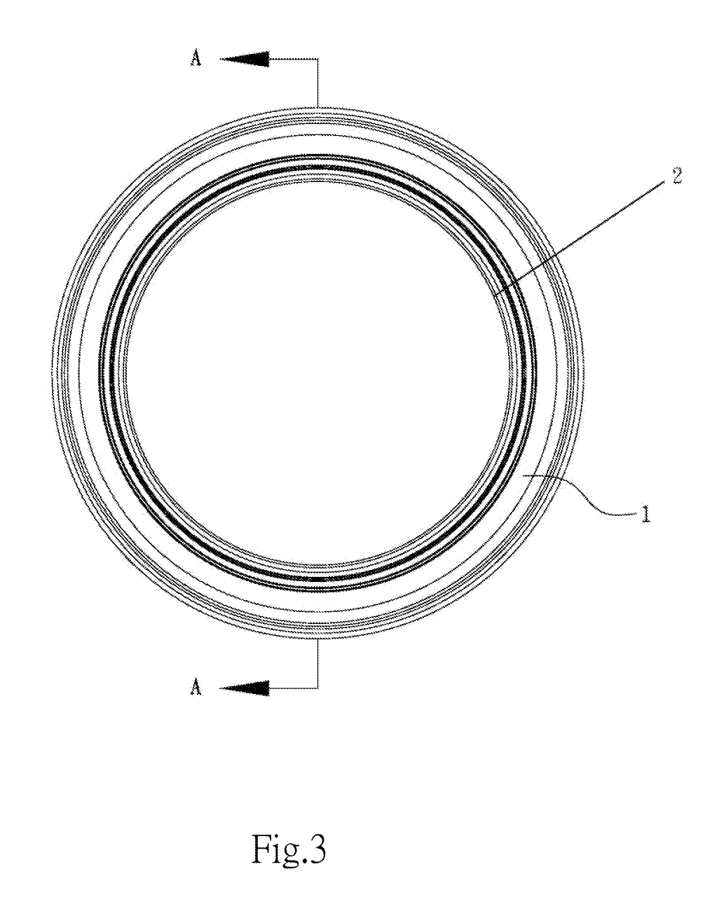

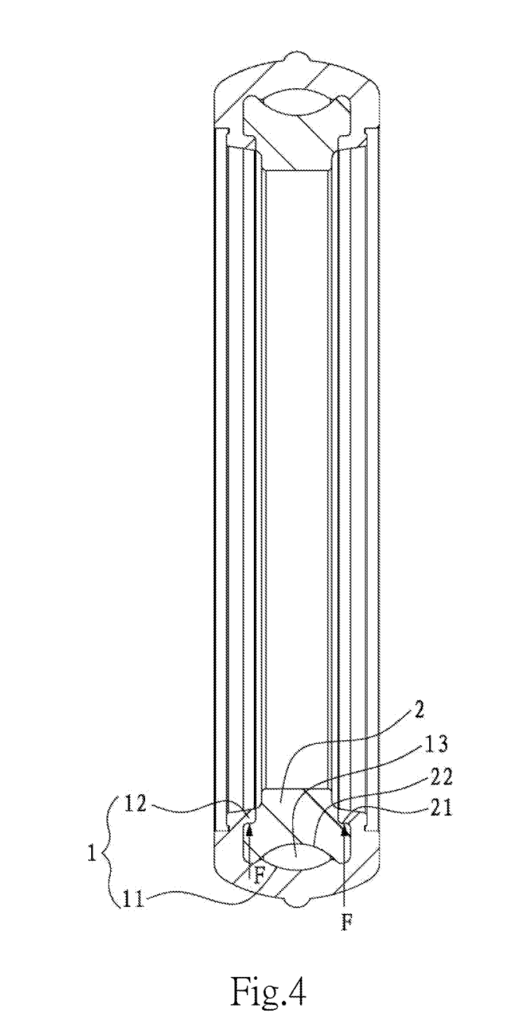

As shown in FIG. 2 to FIG. 4, the present invention discloses a combined tyre. The combined tyre comprises an outer tyre 1 and a core 2.

The outer tyre 1 is an annular component and has an annular core groove 11 therein. Two sides of the core groove 11 of the outer tyre 1 extend inward to form flanges 12, respectively. The flanges 12 constitute the tyre beads of the tyre.

The core 2 is an annular component. The core 2 has a stepped cross-section. When the core 2 is mounted in the core groove 11 of the outer tyre 1 by means of interference fit, a gap 13 is defined between the inner wall of the core groove 11 of the outer tyre 1 and the core 2. A stepped surface 21 of the core 2 is engaged with the flanges 12 of the core groove 11 of the outer tyre 1 to form a tightening force F to press the flanges 12 inward. When the tyre is mounted on a hub, the tightening force F enables the tyre bead of the tyre to fit on the hub tightly, so that the tyre won't fall off.

This can prevent the outer tyre 1 from disengaging from the core 2 effectively after the outer tyre 1 is pressed to expand outward.

The annular outer wall of the core 2 is formed with an annular arc recess 22. The depth of the arc recess 22 corresponds in size to the gap 13 defined between the inner wall of the core groove 11 of the outer tyre 1 and the core 2. When the gap 13 is larger, the hardness of the tyre is lower, on the contrary, the hardness is higher.

The feature of the present invention is that the tyre is composed of the outer tyre and the core fitted in the outer tyre.

The aforesaid is just a preferred embodiment of the present invention. The thickness and pattern of the outer tyre can be changed according to the demand.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A combined tyre, comprising an outer tyre and a core, the outer tyre being an annular component and having an annular core groove therein, the core being an annular component, the core being mounted in the core groove of the outer tyre by means of interference fit, a gap being defined between an inner wall of the core groove of the outer tyre and the core.

2. The combined tyre as claimed in claim 1, wherein two sides of the core groove of the outer tyre extend inward to form flanges respectively, the core having a stepped cross-section, a stepped surface of the core being engaged with the flanges of the core groove of the outer tyre.

3. The combined tyre as claimed in claim 1, wherein an annular outer wall of the core is formed with an annular arc recess.
